(19) United States
(12) Patent Application Publication
(10) Pub. No.: US 2002/0133628 A1
(43) Pub. Date: Sep. 19, 2002

(54) Data caching and annotation system with application to document annotation

(76) Inventors: Ulf Asplund, Grillby (SE); Thomas Bjelkeman-Pettersson, London (GB); Gabriel von Heijne, Djursholm (SE); Sven Stellan Henning Lagerstrom, Hagersten (SE)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/876,261

(22) Filed: Jun. 7, 2001

Related U.S. Application Data
(60) Provisional application No. 60/210,658, filed on Jun. 9, 2000.

(51) Int. Cl. G06F 15/16

(52) U.S. Cl. 709/246; 709/203

(57) ABSTRACT

A method comprises receiving, in an annotation server, a response for data being transmitted to a client from a remote server. Additionally, the addresses are modified in the response to point to the annotation server. The method also comprises modifying the response to include a number of annotations stored in the annotation server that the client has permission to view, wherein the number of annotations are associated with the response. Moreover, the method includes transmitting the response with the modified addresses and the number of annotations that the client has permission to view to the client.

### RELATED APPLICATIONS

This is a continuation of U.S. Provisional Patent Application Serial No. 60/210,658, entitled “Data Catching and Annotation System with Application to Document Annotation” filed Jun. 9, 2000.

### FIELD OF THE INVENTION

The invention relates to the field of communications. More specifically, the invention relates to a system for data caching and annotation for document annotation.

### BACKGROUND OF THE INVENTION

The number of web sites across the Internet continues to increase at a rapid pace. Accordingly, the amount of information available on different web pages across the different web sites also is increasing. Disadvantageously, individuals cannot collaborate on the different web pages without resorting to faxes and printouts with yellow “stickies” with scribbles, or emails with broken links and screen captures, which can take an age to download, or generally really cumbersome tools.

### SUMMARY OF THE INVENTION

A method comprises receiving, in an annotation server, a response for data being transmitted to a client from a remote server. Additionally, the addresses are modified in the response to point to the annotation server. The method also comprises modifying the response to include a number of annotations stored in the annotation server that the client has permission to view, wherein the number of annotations are associated with the response. Moreover, the method includes transmitting the response with the modified addresses and the number of annotations that the client has permission to view to the client.

### BRIEF DESCRIPTION OF THE DRAWINGS

Embodiments of the invention may be best understood by referring to the following description and accompanying drawings that illustrate such embodiments.

FIG. 1 illustrates a system, according to embodiments of the present invention.

FIG. 2 illustrates a flow diagram of an operation of the system of FIG. 1, according to embodiments of the present invention.

### DETAILED DESCRIPTION

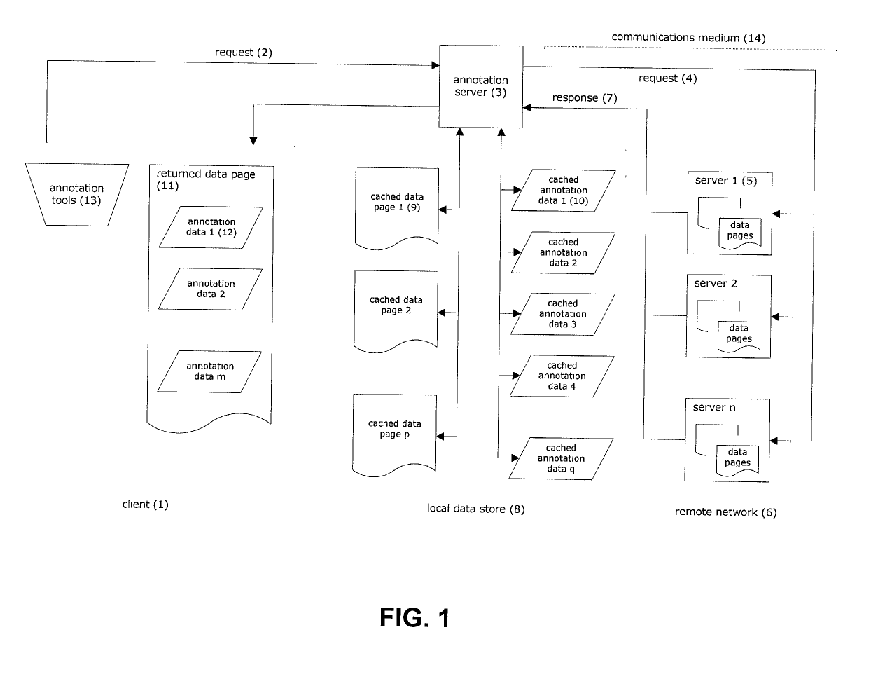

A system is described to collect requested data from remote data stores whose content may be changing over time, cache that data, and display that data to a user along with related annotation data. FIG. 1 illustrates a system, according to embodiments of the present invention. In FIG. 1, the client (1) sends a request (2) to the intermediary annotation server (3). The annotation server rewrites the request and sends a modified request (4) to a server (5) on a remote network (6). The server sends a response (7) back to the annotation server, which stores the time-specific page in its local data store (8). A page can include data of different sizes. The annotation server then sends the cached data page (9) along with any related addressing data and cached annotation data (10) back to the client, which displays the returned data page (11) along with the related annotation data (12).

In addition, annotation tools (13) may be used to add new annotations or modify existing ones on the current data page. These new annotations are similarly stored in the local data store as cached annotation data. The request, response, data pages, addressing data, and annotation data may be exchanged via any suitable data communications medium (14) including wire, RF wireless, microwave wireless, fiber optic, telephone, Internet, or other medium, and combinations thereof.

In an embodiment, the proposed system improves the process of annotating documents by allowing users to use a client to request and view documents along with multiple annotations located at specific data locations within each document. Since time-specific documents are received from the remote servers and cached in the local data store, multiple versions of a changing document can be stored and annotated. In one embodiment, the system allows the user to view a hierarchical list of all documents in the local data store, open them, and add or modify annotations. In one embodiment, users can share annotated documents with other users and groups using the system. A set of modifiable permissions allows users to restrict the actions other users can perform on annotations located on the shared documents.

In an embodiment, the annotations are displayed as notes along with the original document, for example, as moveable notes overlaid on the original document. The notes may contain links to additional tools or information such as annotations, documents, or threaded discussions. In one embodiment, the system is manifest in part by the annotation server and a system of one or more networked computing devices. The annotation server communicates with the client and the remote network using standard networking protocols. In one such embodiment, the system includes annotation tools, which may be stored at the client. In another embodiment, these annotation tools may be transmitted from the annotation server to the client (similar to the transmissions of the annotated documents from the annotation server to the client).

In an embodiment, the request sent to the annotation server is manifest in part by a data page address, for example a web page URL, along with additional addressing data, for example web browser cookie data. The response sent from the remote server to the annotation server is manifest in part by a data page, for example a web page, along with additional addressing data that may be necessary for future requests to the same server, for example updated web browser cookie data.

In one embodiment of the present invention, the system functions as a tool in the collaborative editing of documents. The documents are published on a network by a creator, and shared with a group of other users using the system. The other users comment on the document by adding annotations and sharing them with the creator, who reviews the comments and prepares the successive versions of the document for review.

In one embodiment of the present invention, the system is utilized by an individual doing research to collect time-specific copies and take notes on publicly available documents. The collected documents are stored and organized in a hierarchical form using the system. The system can then be used to make the collection of documents and annotations available to an audience.

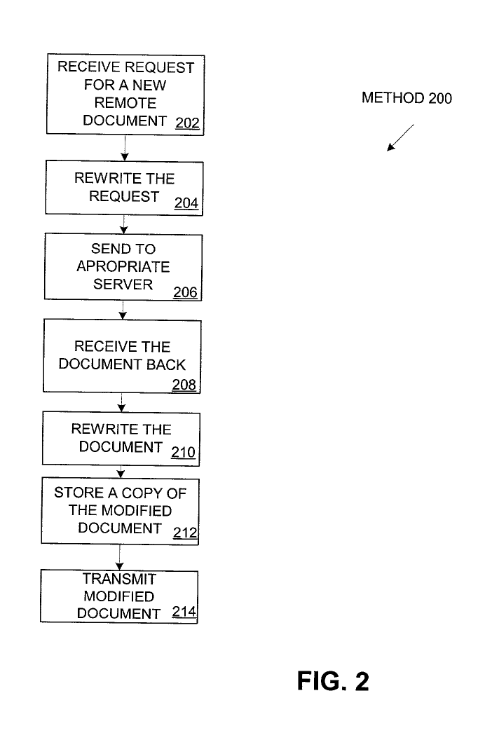

FIG. 2 illustrates a flow diagram of an operation of the system of FIG. 1, according to embodiments of the present invention. The user starts the client. The user requests a new remote document using the client. The client sends a request for the document, consisting of the document address and any additional addressing data, to the annotation server, which is received by the annotation server, at process block 202.

The annotation server rewrites the request for the document, at process block 204, and sends it to the appropriate server on the remote network, at process block 206. In one such embodiment, this rewriting of the request includes modification to add cookie data. In an embodiment, this rewriting of the request includes modification to indicate the type of browser executing on the client. The remote server sends the document back to the annotation server, along with any updated addressing data, at process block 208. The annotation server rewrites the document so that any links to other documents point back through the annotation server, at process block 210, and stores a copy in the local data store, at process block 212. This rewriting of the document, therefore, allows for the employment of a standard unmodified web browser to be executing on the client. Accordingly, the client's normal link-following behavior results in the link-requested documents to be requested through the annotation server. These link-requested documents can then be cached and thus annotated.

The annotation server rewrites the additional addressing data to point back through the annotation server and sends it on to the client for use in future requests. The annotation server sends the stored document to the client to be displayed to the user, along with any related annotations and any annotation tools available to the user, at process block 214.

The user reads the document and the annotations using the client, and chooses a link in the document to request a new document. The client sends the address of the new document to the annotation server along with any additional addressing data. The annotation server rewrites the request, then sends it to the remote server, which sends the requested document back to the annotation server along with any additional addressing data. The annotation server rewrites the links in the document and stores a copy in the local data store, then sends the rewritten document and any related annotations back to the client to be displayed to the user. The annotation server rewrites the additional addressing data to point back through the annotation server and sends it back to the client as well.

The user requests a previously viewed document from the hierarchical list of documents in the local data store. The annotation server checks for a more recent version of the document on the remote server, but does not find a more recent version. The annotation server sends the most recent cached document stored in the local data store along with related annotations back to the client to be displayed to the user. The user views the document and uses the annotation tools to add annotations or modify existing ones. The user chooses to share the document and annotations with another user on the system.

The different network elements include memories, processors, and/or Application Specific Integrated Circuits (“ASICs”). Such memory includes a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media; optical storage media, flash memory devices, electrical, optical, acoustical, or other form of propagated signals (e.g., carrier waves, infrared signals, digital signals, etc.), etc. Although the present invention has been described with reference to specific exemplary embodiments, it will be evident that various modifications and changes may be made to these embodiments without departing from the broader spirit and scope of the invention.

What is claimed is:

1. A method comprising:
receiving, in an annotation server, a response for data being transmitted to a client from a remote server;
modifying addresses in the response to point to the annotation server;
modifying the response to include a number of annotations stored in the annotation server that the client has permission to view, wherein the number of annotations are associated with the response; and
transmitting the response with the modified addresses and the number of annotations that the client has permission to view to the client.

2. The method of claim 1, further comprising storing the response with the modified addresses and the number of annotations that the client has permission to view in memory in the annotation server.

3. The method of claim 1, further comprising receiving from the client the modified response and a new annotation associated with the modified response;

4. The method of claim 3, further comprising storing the modified response and the new annotation from the client in the memory of the annotation server.

5. The method of claim 1, further comprising receiving from the client the response and a modification of one of the number of annotations that the client has permission to view.

6. The method of claim 5, further comprising storing the modified response and the modification of one of the number of annotations that the client has permission to view in the memory of the annotation server.

7. A method executing in an annotation server, the method comprising:
receiving, from a client, a request for data from a remote server, the data having address data;
modifying the request to indicate that the client is transmitting the request for data to the remote server;
transmitting the request to the remote server;
receiving response data from the remote server based on the request, the response data having updated address data;
modifying the updated address data in the response data to point to the annotation server;
modifying the response data to include a number of annotations that the client has permission to view and that are associated with the response data, wherein the number of annotations are stored in the annotation server;
storing the modified response in memory of the annotation server; and
transmitting the response with the updated address data and the number of annotations that the client has permission to view to the client.

8. The method of claim 7, further comprising receiving from the client the response and a new annotation associated with the response.

9. The method of claim 8, further comprising storing the response and the new annotation from the client in the memory of the annotation server.

10. The method of claim 7, further comprising receiving from the client the response and a modification of one of the number of annotations that the client has permission to view.

11. The method of claim 10, further comprising storing the response and the modification of one of the number of annotations that the client has permission to view in the memory of the annotation server.

12. The method of claim 7, wherein the request for data includes a web page document.

13. The method of claim 12, wherein the number of annotations is selected from the group consisting of movable notes overlaid on the web page document, links to other web page documents and links to threaded discussions.

14. A machine-readable medium that provides instructions, which when executed by a machine, causes the machine to perform operations comprising:
receiving, in an annotation server, a response for data being transmitted to a client from a remote server;
modifying addresses in the response to point to the annotation server;
modifying the response to include a number of annotations stored in the annotation server that the client has permission to view, wherein the number of annotations are associated with the response; and
transmitting the response with the modified addresses and the number of annotations that the client has permission to view to the client.

15. The machine-readable medium of claim 14, further comprising storing the response with the modified addresses and the number of annotations that the client has permission to view in memory in the annotation server.

16. The machine-readable medium of claim 14, further comprising receiving from the client the modified response and a new annotation associated with the modified response;

17. The machine-readable medium of claim 16, further comprising storing the modified response and the new annotation from the client in the memory of the annotation server.

18. The machine-readable medium of claim 14, further comprising receiving from the client the response and a modification of one of the number of annotations that the client has permission to view.

19. The machine-readable medium of claim 18, further comprising storing the modified response and the modification of one of the number of annotations that the client has permission to view in the memory of the annotation server.

20. The machine-readable medium of claim 14, wherein the number of annotations is selected from the group consisting of movable notes overlaid on the data, links to web page documents and links to threaded discussions.
